(19) United States
(12) Patent Application Publication
(10) Pub. No.: US 2018/0355635 A1
(43) Pub. Date: Dec. 13, 2018

(54) LOCK MONITORING DEVICE, METHOD AND SYSTEM FOR MONITORING LOCK

(71) Applicant: THOMSON Licensing, Issy-les-Moulineaux (FR)

(72) Inventors: Fei LU, Beijing (CN); Kai XIE, BEIJING (CN)

(73) Assignee: THOMSON Licensing, Issy-les-Moulineaux (FR)

(21) Appl. No.: 15/781,342

(22) PCT Filed: Dec. 4, 2015
(86) PCT No.: PCT/CN2015/096434

§ 371 Date: Jun. 4, 2018

(51) Int. Cl. E05B 45/06; E05B 39/04

(52) U.S. Cl. CPC E05B 45/06; E05B 2045/0635; E05B 39/04

(57) ABSTRACT

A lock monitoring device (10, 70, 80) comprises a sensor (101) configured to sense a rotation degree of a lock with respect to a predefined direction, a controller (103) configured to determine the status of the lock based on the sensed rotation degree from the sensor (101), and a communication module (105) configured to communicate with an external device. The controller (103) is further configured to, upon detecting a change in the status of the lock, control the communication module (105) to transmit the status of the lock to the external device. And a method and system for monitoring a lock are also provided.

### TECHNICAL FIELD

The disclosure relates to safety monitoring, and more particularly, to lock monitoring devices, methods and systems for monitoring a lock.

### BACKGROUND

Nowadays, there are a lot of doors designed with no automatic locking, that is, when people get out of their house and close the door, they have to lock on manually. As a result, people are often worried about whether they have forgotten locking on the door when they leave their house. It happens also when people enter a room, they may forget spinning the door knob to really lock on the door. This is rather unsafe.

There have been many door sensors to detect if a door is close or open, but they are design for door rather than for lock, and thus they cannot detect if a lock installed on the door is on or off, even though the door is closed.

There is a need for a technique of monitoring the status of a lock, such as a door lock and reporting the status to a user, so that the user can easily learn whether the lock is actually closed, thereby improving convenience and safety.

### SUMMARY

According to an aspect of the disclosure, a lock monitoring device is provided comprising a sensor configured to sense a rotation degree of a lock with respect to a predefined direction, a controller configured to determine the status of the lock based on the sensed rotation degree from the sensor, and a communication module configured to communicate with an external device. The controller is further configured to, upon detecting a change in the status of the lock, control the communication module to transmit the status of the lock to the external device.

In an embodiment, the lock monitoring device is attachable to a knob whose motion is synchronized with the lock, and the sensor is configured to sense a rotation degree of the knob as the rotation degree of the lock when the lock monitoring device is attached to the knob.

In an embodiment, the controller is further configured to keep a history of rotation degree of the lock, and to determine the status of the lock by obtaining a current rotation degree of the lock from the sensor, updating the history of rotation degree with the current rotation degree if the current rotation degree is different from the last rotation degree in the history, and determining the status of the lock based on the updated history.

In an embodiment, the communication module is further configured to receive a setting command to set up the lock monitoring device from the external device, and the controller is further configured to set up an initial state of the lock monitoring device according to the received setting command.

In an embodiment, the lock monitoring device further comprises a setting module through which a user can manually set up an initial state of the lock monitoring device when the lock monitoring device is attached to a knob.

In an embodiment, the initial state comprises at least an offset degree of the lock monitoring device with respect to the predefined direction, and the controller is further configured to determine the status of the lock based on the sensed rotation degree and the offset degree.

In an embodiment, the communication module is further configured to receive a wakeup command to wake up the lock monitoring device from the external device, and the controller is further configured to wake up the lock monitoring device according to the received wakeup command.

In an embodiment, the sensor is further configured to, upon sensing a motion of the lock, trigger an interrupt to wake up the lock monitoring device.

In an embodiment, the communication module is further configured to receive a sleep command to force the lock monitoring device into a sleep state from the external device, and the controller is further configured to force the lock monitoring device into the sleep state according to the received sleep command.

In an embodiment, the lock monitoring device automatically enters a sleep state when a predefine time period elapses after the lock is closed.

In an embodiment, the controller is further configured to, upon detecting a change in the status of the lock, control an alarm indicator included in the lock monitoring device to issue an alarm, and/or control the communication module to transmit an alarm message to the external device through which the alarm message is to be reported to a user.

According to another aspect of the disclosure, a method for monitoring a lock is provided comprising: detecting a rotation degree of a lock with respect to a predefined direction; determining the status of the lock based on the detected rotation degree; and upon detecting a change in the status of the lock, transmitting the status of the lock to an external device.

In an embodiment, the method further comprises keeping a history of rotation degree of the lock, and wherein determining the status of the lock comprises: obtaining a current rotation degree of the lock, updating the history of rotation degree with the current rotation degree if the current rotation degree is different from the last rotation degree in the history, and determining the status of the lock based on the updated history.

In an embodiment, the method further comprises, upon detecting a change in the status of the lock: issuing an alarm through an alarm indicator, and/or transmitting an alarm message to the external device through which the alarm message is to be reported to a user.

According to a further aspect of the disclosure, a system for monitoring a lock is provided comprising: a lock monitoring device, and a first external device configured to communicate with the lock monitoring device. The lock monitoring device comprises: a sensor configured to sense a rotation degree of a lock with respect to a predefined direction; a controller configured to determine the status of the lock based on the sensed rotation degree from the sensor; and a communication module configured to communicate with the first external device. The controller is further configured to, upon detecting a change in the status of the lock, control the communication module to transmit the status of the lock to the first external device, and the first external device is further configured to present the status of the lock to a user.

In an embodiment, the controller is further configured to, upon detecting a change in the status of the lock, control the communication module to transmit an alarm message to the first external device, and the first external device reports the alarm message to the user.

In an embodiment, the first external device is further configured to transmit a setting command to the lock monitoring device, and the controller is further configured to set up an initial state of the lock monitoring device according to the setting command received by the communication module.

In an embodiment, the first external device is further configured to transmit a wakeup command to the lock monitoring device, and the controller is further configured to wake up the lock monitoring device according to the wakeup command received by the communication module.

In an embodiment, the first external device is further configured to transmit a sleep command to the lock monitoring device, and the controller is further configured to force the lock monitoring device into the sleep state according to the sleep command received by the communication module.

In an embodiment, the system further comprises a second external device configured to communicate with the first external device, and wherein the first external device is further configured to transmit the status of the lock received from the lock monitoring device to the second external device, and the second external device is further configured to present the status of the lock to the user.

In an embodiment, the communication between the lock monitoring device and the first external device and the communication between the first and second external devices comprise wireless communication including Bluetooth.

According to a still further aspect of the disclosure, a system for monitoring a lock, the system comprising a lock monitoring device, a first external device, and a second external device. The first external device is configured to act as a coordinator between the lock monitoring device and the second external device. The lock monitoring device comprises: a sensor configured to sense a rotation degree of a lock with respect to a predefined direction; a controller configured to determine the status of the lock based on the sensed rotation degree from the sensor; and a communication module configured to communicate with the first external device. The controller is further configured to, upon detecting a change in the status of the lock, control the communication module to transmit the status of the lock to the second external device through the first external device, and the second external device is further configured to present the status of the lock to a user.

In an embodiment, the controller is further configured to, upon detecting a change in the status of the lock, control the communication module to transmit an alarm message to the second external device through the first external device, and the second external device reports the alarm message to the user.

In an embodiment, the second external device is further configured to transmit a setting command to the lock monitoring device through the first external device, and the controller is further configured to set up an initial state of the lock monitoring device according to the setting command received by the communication module.

In an embodiment, the second external device is further configured to transmit a wakeup command to the lock monitoring device through the first external device, and the controller is further configured to wake up the lock monitoring device according to the wakeup command received by the communication module.

In an embodiment, the second external device is further configured to transmit a sleep command to the lock monitoring device through the first external device, and the controller is further configured to force the lock monitoring device into the sleep state according to the sleep command received by the communication module.

In an embodiment, the communication between the lock monitoring device and the first external device comprises wireless communication including Zigbee, and the communication between the first and second external devices comprise wireless communication over internet.

### BRIEF DESCRIPTION OF THE DRAWINGS

The above and other objects, features and advantages will be more apparent from the following description of embodiments with reference to the figures, in which:

FIG. 1 is a schematic block diagram showing a lock monitoring device according to an embodiment of the disclosure;

FIG. 2 is a schematic diagram showing association between rotation degree and status of a lock according to an embodiment of the disclosure;

FIG. 3 is a schematic diagram showing a history of rotation degree of a lock according to an embodiment of the disclosure;

FIG. 4 is a flowchart illustrating a process of determining the status of a lock according to an embodiment of the disclosure;

FIG. 5 is a schematic diagram showing setting an initial state of a lock according to an embodiment of the disclosure;

FIG. 6 is a flowchart illustrating a method for monitoring a lock according to an embodiment of the disclosure;

FIG. 7 is a schematic diagram showing a system for monitoring a lock according to an embodiment of the disclosure; and

FIG. 8 is a schematic diagram showing a system for monitoring a lock according to another embodiment of the disclosure.

### DETAILED DESCRIPTION

The embodiments of the disclosure will be detailed below with reference to the drawings. It should be noted that the following embodiments are illustrative only, rather than limiting the scope of the disclosure. Detailed description of any well-known steps, devices, components and the like is omitted here to avoid obscuring of the disclosure.

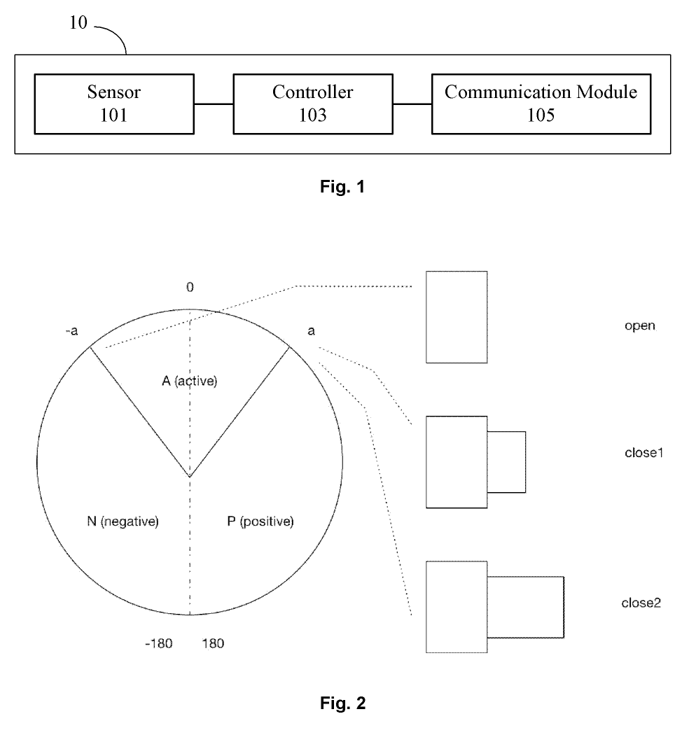

FIG. 1 is a schematic block diagram showing a lock monitoring device according to an embodiment of the disclosure. The lock monitoring device 10 may include a sensor 101, a controller 103, and a communication module 105. Although not shown in FIG. 1, the lock monitoring device 10 may further include a power supply, such as a battery.

The sensor 101 may sense a rotation degree of a lock with respect to a predefined direction, for example, a vertical direction along the length of a door in which the lock is installed. The sensor 101 may be an inertial sensor implemented with gyroscope, accelerator with as least one axis or combination thereof, as long as it can detect degree. The controller 103 may determine the status of the lock based on the sensed rotation degree from the sensor 101. The communication module 105 may communicate with an external device (not shown), such as mobile phone. The controller 103 may control the communication module 105 to transmit the status of the lock to the external device in response to detecting a change in the status of the lock. The external device may present the status of the lock to its user. The communication module 105 may operate according to various communication protocols, such as Bluetooth, Zigbee, or the like.

In one embodiment, the lock monitoring device 10 may further include an alarm indicator (not shown). When the controller 103 detects a change in the status of the lock, the controller 103 controls the alarm indicator to issue an alarm. The alarm indicator may be implemented with at least one of a buzzer or a LED (Light Emitting Diode) for reporting acoustic and/or visual alarm to the user.

In one embodiment, when the controller 103 detects a change in the status of the lock, the controller 103 controls the communication module 105 to transmit an alarm message to the external device. The external device, such as mobile phone, may display the alarm message to the user.

In one embodiment, the lock monitoring device 10 is attachable to a knob whose motion is synchronized with the lock, and the sensor 103 senses a rotation degree of the knob as the rotation degree of the lock when the lock monitoring device 10 is attached to the knob. As an example, the lock monitoring device 10 may be designed as a wrapper of the knob, and powered by battery. The wrapper may be fixed onto the knob with glue, adhesive tap, or any other attachment mechanism.

In one embodiment, the communication module 105 may receive a setting command to set up the lock monitoring device 10 from the external device. The controller 103 may set up an initial state of the lock monitoring device 10 according to the received setting command. In another embodiment, the lock monitoring device 10 may further include a setting module (not shown) through which a user can manually set up an initial state of the lock monitoring device 10 when the lock monitoring device 10 is attached to a knob. The setting module may be embodied as a button, a key or the like. The setting up operation will be described below with reference to the figures.

It should not to predict the direction of lock monitoring device 10 installed on a door knob, and so there might be an offset of degree with respect to a predefined direction, for example, a vertical direction along the length of a door in which the lock is installed. The initial state may include at least such offset degree of the lock monitoring device 10 with respect to the predefined direction, and the controller 103 determines the status of the lock based on the sensed rotation degree and the offset degree.

In case that the lock monitoring device 10 is powered by battery, power-saving is important, and the device 10 should keep sleeping when nobody touches door. In one embodiment, the communication module 105 may receive a sleep command to force the lock monitoring device 10 into a sleep state from the external device, and the controller 103 may force the lock monitoring device 10 into the sleep state according to the received sleep command. In another embodiment, the lock monitoring device 10 may automatically enter a sleep state when a predefine time period (e.g., 1 min) elapses after the lock is closed.

In one embodiment, the communication module 105 may receive a wakeup command to wake up the lock monitoring device 10 from the external device, and the controller 103 may wake up the lock monitoring device according to the received wakeup command. In another embodiment, the sensor 101 may trigger an interrupt to wake up the lock monitoring device 10 upon sensing a motion of the lock caused by, for example, user's touch on the door or lock. Alternatively, the lock monitoring device 10 may include a vibration sensor (not shown). When a user opens a door then wants to close it and lock on, the door must be vibrated, and the vibration sensor senses such vibration and wakes up the lock monitoring device 10.

Below, a process of determining the status of a lock will be detailed with reference to FIGS. 2 to 4.

FIG. 2 is a schematic diagram showing association between rotation degree and status of a lock according to an embodiment of the disclosure. For easier description and understanding, it is assumed that the lock monitoring device 10 is attached to a door knob whose motion is synchronized with a lock installed in the door, a vertical direction along the length of a door is the direction along the dashed line 0-180 degrees as shown in FIG. 2, and there is no offset with respect to the vertical direction. Accordingly, the lock and the knob are rotated in the range of −180 degrees to 180 degrees, with 0 degree representing a start point of rotation. Further, there is generally a threshold degree “a” for a lock. The lock is active (not really open or closed) when it is rotated within the range of −a to a. We may denote this range as area A. As the user is spinning the key on lock, the lock rotates and the knob follows the rotation. With respect to FIG. 2, as the rotation degree increases from −a to a, a cylinder of the lock emerges from within the door, which means to become locked on or become “more” closed. Generally, the cylinder can become longer every time the user spins 360 degree when the rotation degree passes from −a to a (denoted as “close1” and “close2” in FIG. 2). We may denote the range of a to 180 degrees as area P, as the lock is closed in this range, and thus the status of the lock may be called positive. Oppositely, when the rotation degree passes from a to −a, the cylinder becomes shorter meaning from closed to open or “less” closed (denoted as “open” in FIG. 2). We may denote the range of −180 to −a as area N, as the lock becomes open or less closed in this range, and thus the status of the lock may be called negative.

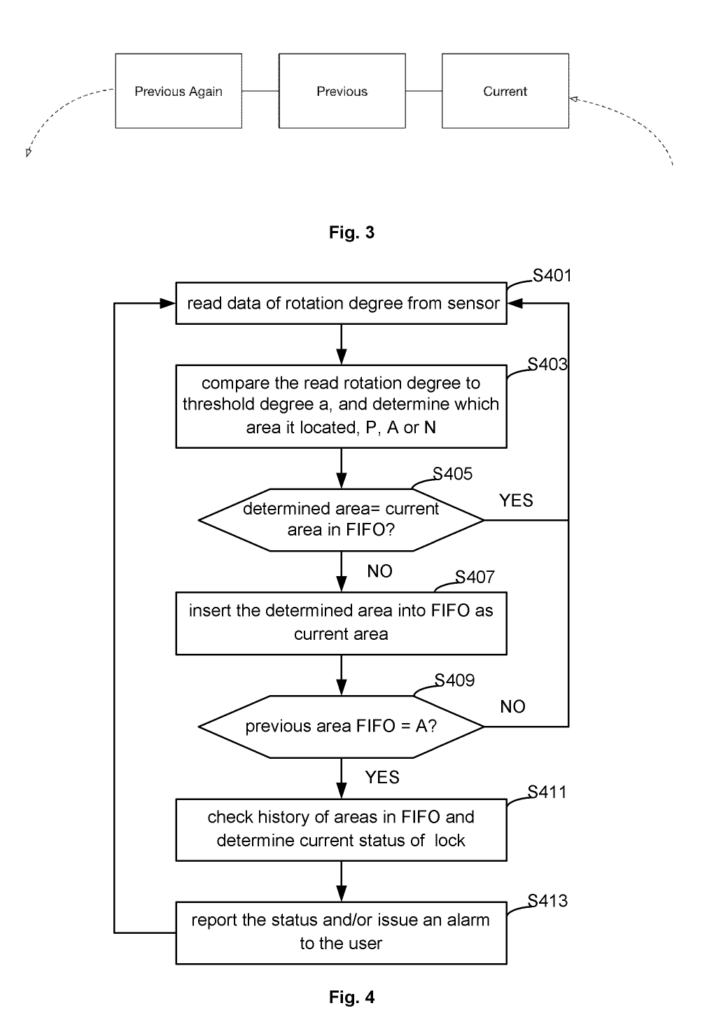

When the user touches the door or lock, the lock monitoring device 10 may be waken up, and start to operate. As the user spins the key, the sensor 101 senses the rotation degree of the lock, and the controller 103 starts to determine the status of the lock. In one embodiment, the controller 103 may keep a history of rotation degree of the lock, and to determine the status of the lock by obtaining a current rotation degree of the lock from the sensor 101, updating the history of rotation degree with the current rotation degree if the current rotation degree is different from the last rotation degree in the history, and determining the status of the lock based on the updated history. As shown in FIG. 3 which is a history of rotation degree of a lock according to an embodiment of the disclosure, The controller 103 may keep a FIFO (First In First Out) to record at least 3 elements where are current, previous and previous again areas P, A or N corresponding to rotation degrees. FIG. 4 is a flowchart illustrating a process of determining the status of a lock according to an embodiment of the disclosure. As shown in FIG. 4, at S401 the controller 103 reads data of rotation degree from the sensor 101 at a preset frequency, for example, 100 Hz. At S403, the controller 103 compares the read rotation degree to the threshold degree a, and determines which area it located, P, A or N. Specifically, if the rotation degree is with the range of −a to a, the area is A; if the rotation degree is with the range of a to 180, the area is P; and if the rotation degree is with the range of −180 to −a, the area is N. At S405, the controller 103 checks whether the determined area is the same as the last (or current) one of the three areas kept in the FIFO. If the check result is YES, the flow returns to S401 where the controller 103 continues reading data from the sensor 101. If the check result is NO, the controller 102 updates the areas in the FIFO by inserting the determined area into the FIFO as current area, and removing the earliest (“previous again” in FIG. 3) area at S407. Then, the controller 103 checks whether the previous area (“previous” in FIG. 3) in the FIFO is “A” at S409. If the check result is NO, it means that there is no change in the status of the lock, and the flow returns to S401. If the check result is YES, it means that the status of the lock is changing, for example, as the user is spinning the key. Then at S411, the controller 103 checks the history of the areas in the FIFO and determines current status of the lock. Specifically, If the history is N-A-P (before to now), it means the lock is moved to being closed or being higher-level closed. If the history is P-A-N, it means that the lock is moved to being lower-level closed or being open. At S413, as the status of the lock is changed, the controller 103 controls to report the status and/or issue an alarm to the user. Then, the flow returns to S401, and the controller 103 reads further data from the sensor 101.

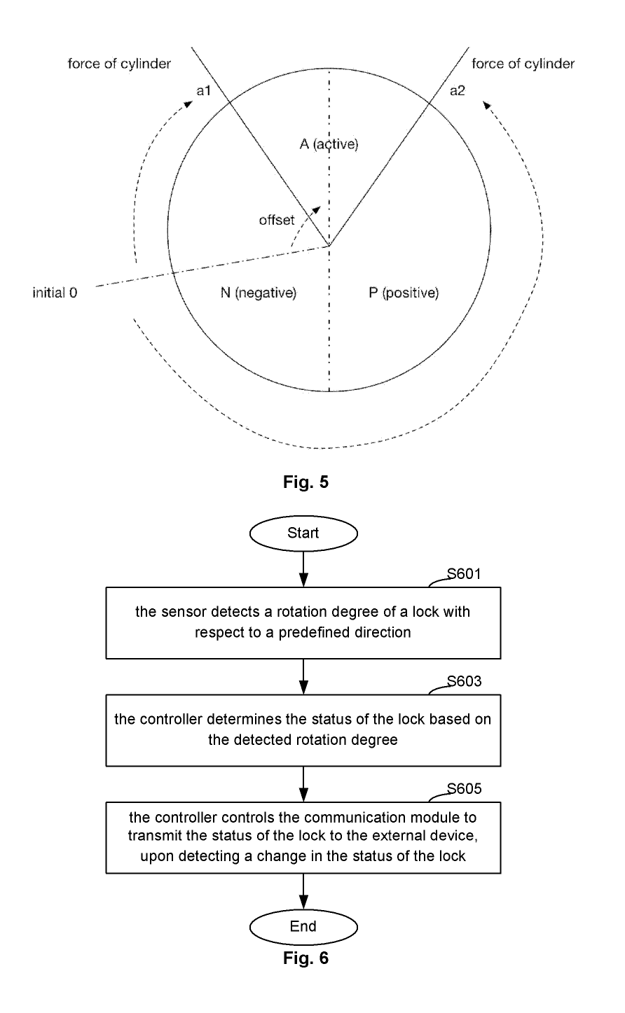

FIG. 5 is a schematic diagram showing setting an initial state of a lock according to an embodiment of the disclosure. As described above, it should not to predict in which direction the lock monitoring device 10 is installed on a door knob, and so there might be an offset of degree with respect to the predefined direction, such as vertical direction shown in FIG. 2. Another difficulty is to determine the threshold degree “a” for a lock. As an example, the user may perform the setting as follows.
i) User installs the lock monitoring device 10 to a door knob and presses a button (e.g., on the setting module) on the lock monitoring device 10 to start the setup.
ii) User spins cylinder by key or knob from “initial 0” which represents the direction in which the device 10 is installed until a1, where the user starts feeling a force of resistance of cylinder. At this time, the user presses a button to set a1.
iii) User spins cylinder from current location along an opposite direction until a2, where the user starts feeling the force again, then the user press a button to set a2.
iv) The device 10 sets offset degree =(a1+a2)/2 and threshold degree a=(a2-a1)/2, and notifies the user of these settings.

Alternatively, the communication module 105 may receive a setting command to set up the lock monitoring device 10 from the external device. The controller 103 may set up an initial state of the lock monitoring device 10 according to the received setting command. This will be described with more details in the following section.

FIG. 6 is a flowchart illustrating a method for monitoring a lock according to an embodiment of the disclosure. At S601, the sensor 101 detects a rotation degree of a lock with respect to a predefined direction. At S603, the controller 103 determines the status of the lock based on the detected rotation degree. Specifically, the controller 103 keeps a history of rotation degree of the lock, and determines the status of the lock by obtaining a current rotation degree of the lock, updating the history of rotation degree with the current rotation degree if the current rotation degree is different from the last rotation degree in the history, and determining the status of the lock based on the updated history. At S605, the controller 103 controls the communication module 105 to transmit the status of the lock to the external device, upon detecting a change in the status of the lock. In one embodiment, upon detecting a change in the status of the lock, the controller 103 may further control an alarm indicator included in the lock monitoring device 10 to issue an alarm, and/or control the communication module 105 to transmit an alarm message to the external device through which the alarm message is to be reported to the user.

The lock monitoring device 10 of FIG. 1 may be applied in a system which further includes a first external device configured to communicate with the lock monitoring device 10. The first external device may be a portable device that can be carried by its user, and thus the user can be informed of the status of the lock with the portable device. For example, the first external device may be a mobile phone. The first external device may communicate with the communication module 105 of the lock monitoring device 10, for example, in accordance with various wireless communication protocols, such as Bluetooth, Zigbee, and the like. The controller 103 of the lock monitoring device 10 may control the communication module 105 to transmit the status of the lock to the first external device, upon detecting a change in the status of the lock. The first external device may present the status of the lock to the user, for example, by displaying the status on a screen or generating acoustic message of the status through a speaker.

In one embodiment, the controller 103 may further control the communication module 105 to transmit an alarm message to the first external device, and the first external device may report the alarm message to the user.

In one embodiment, the first external device may transmit a setting command to the lock monitoring device 10, and the controller 103 may set up an initial state of the lock monitoring device 10 according to the setting command received by the communication module 105.

In one embodiment, the first external device may transmit a wakeup command to the lock monitoring device 10, and the controller 103 may wake up the lock monitoring device 10 according to the wakeup command received by the communication module 105.

In one embodiment, the first external device may transmit a sleep command to the lock monitoring device 10, and the controller 103 may force the lock monitoring device 10 into the sleep state according to the sleep command received by the communication module 105.

In one embodiment, the system may further include a second external device configured to communicate with the first external device. Communication between the first and second external devices may be conducted in accordance with various wireless communication protocols, such as Bluetooth. For example, the second external device may be a watch paired with the mobile phone. The first external device may transmit the status of the lock received from the lock monitoring device to the second external device, and the second external device may present the status of the lock to the user.

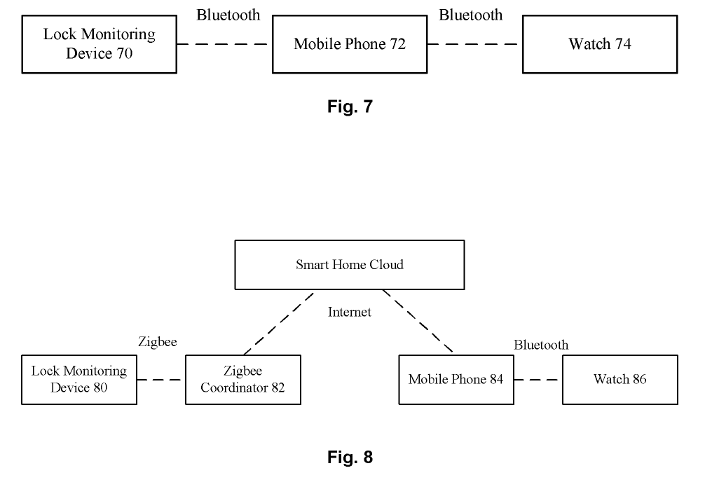

FIG. 7 is a schematic diagram showing an example of the above system for monitoring a lock according to an embodiment of the disclosure. The system includes a lock monitoring device 70 (e.g., the lock monitoring device 10), a mobile phone 72, and a watch 74. The lock monitoring device 70 is attached to a door knob and wirelessly connects to the mobile phone 72 to report the lock status. The mobile phone 72 displays the lock status visually and alarms the user. The mobile phone 72 also sends the lock status and/or the alarm to the watch 74 paired with the mobile phone 72 through Bluetooth.

In this example, the lock monitoring device 70 and the mobile phone 72 communicate with each other through Bluetooth, and each have a corresponding Bluetooth module. Data is encapsulated in Bluetooth packet and transmitted from the lock monitoring device 70 to the mobile phone 72. Table 1 below shows an example of the data.

TABLE 1

| Data | Value and Meaning |
|---|---|
| angle | −180~+180 degrees |
| status | 0 means lock open |
| | 1 means lock closed (turning 1 rounds) |
| | 2 means lock closed (turning 2 rounds) |
| | 3 means lock closed (turning 3 rounds) |

The mobile phone 72 may transmit commands to the lock monitoring device 70 through Bluetooth. The commands are encapsulated in Bluetooth packet. Table 2 below shows an example of the commands.

TABLE 2

| Name | Value and Meaning |
|---|---|
| angle of | −180~+180 degree, meaning the lock becomes close at |
| close point | this point, for setup |
| angle of | −180~+180 degree, meaning the lock becomes open at |
| open point | this point, for setup |
| start round | “STARTROUND”, meaning the current round of lock. User |
| | specifies it when spinning the lock to unlocked status, for |
| | setup |
| stop alarm | “STOP”, meaning stop alarm |
| sleep forced | “SLEEP”, meaning short time disabling |
| wakeup | “WAKEUP”, meaning enabling |
| forced | |

Initially, the lock monitoring device 10 does not know which round the current position of lock is in, because every round looks the same. For setup, the user specifies where is round 0 (unlock status). For example, the user spins the lock to unlocked status and then sends a command “start round” to the lock monitoring device 10. Then, the user may further send a command to indicate that the lock starts working at this point. In this way, the start position of the lock can be set up correctly.

The lock monitoring device 10 of FIG. 1 may be applied in a system which further includes first and second external devices. The first external device may act as a coordinator between the lock monitoring device 10 and the second external device. The controller 103 of the lock monitoring device 10, upon detecting a change in the status of the lock, may control the communication module 105 to transmit the status of the lock to the second external device through the first external device, and then the second external device may present the status of the lock to its user.

FIG. 8 is a schematic diagram showing an example of the above system for monitoring a lock according to another embodiment of the disclosure. The system includes a lock monitoring device 80 (e.g., the lock monitoring device 10), a Zigbee coordinator 82, a mobile phone 84, and a watch 84 paired with the mobile phone 84 through Bluetooth. The lock monitoring device 80 has a Zigbee module and is paired with the Zigbee coordinator 82 at home. The Zigbee coordinator 82 is connected to smart home service in cloud and is responsible for sending data coming from the lock monitoring device 80 to the service. The service sends the data to the mobile phone 84 over Internet. The mobile phone 84 also sends the data to the watch 86. The mobile phone 84 may transmit commands to the lock monitoring device 80 through the cloud service and the Zigbee Coordinator 82. The data and commands are the same as the above example using Bluetooth, and the difference is that the data and command are encapsulated in Zigbee packet rather than Bluetooth packet.

With the solutions of the present disclosure, the user can easily learn whether the lock is actually closed, thereby improving convenience and safety. The lock monitoring device can be in a form of a wrapper that is attachable to a door knob, and thus it is not required to change the lock which is really not easy for high-end door and for people without practical ability.

The present disclosure may be implemented by a computer program product, for example, in the form of a computer-readable medium carrying computer program codes structured in computer program modules. The computer program modules, when executed in a processor, cause the image capturing device or the image processing apparatus to perform the actions described above in conjunction with the figures mentioned above. Alternatively, at least one of the code means may be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. For example, the computer program product may be a flash memory, a Random-access memory (RAM), a Read-Only Memory (ROM), or an EEPROM, and the computer program modules described above could in alternative embodiments be distributed on different computer program products in the form of memories.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

1. A lock monitoring device comprising:
a sensor configured to sense a rotation degree of a lock with respect to a predefined direction;
a controller configured to determine the a status of the lock based on the sensed rotation degree from the sensor; and
a communication module configured to communicate with an external device;
wherein the controller is further configured to, upon detecting a change in the status of the lock, control the communication module to transmit the status of the lock to the external device.

2. The lock monitoring device of claim 1, wherein the lock monitoring device is attachable to a knob whose motion is synchronized with the lock, and the sensor is configured to sense a rotation degree of the knob as the rotation degree of the lock when the lock monitoring device is attached to the knob.

3. The lock monitoring device of claim 1, wherein the controller is further configured to keep a history of rotation degree of the lock, and to determine the status of the lock by:
obtaining a current rotation degree of the lock from the sensor,
updating the last rotation degree in the history of rotation degree with the current rotation degree if the current rotation degree is different from the last rotation degree in the history, and
determining the status of the lock based on the updated last rotation degree in the history.

4. The lock monitoring device of claim 1, wherein the communication module is further configured to receive a setting command to set up the lock monitoring device from the external device, and the controller is further configured to set up an initial state of the lock monitoring device according to the received setting command

5. The lock monitoring device of claim 1, further comprising a setting module through which a user can manually set up an initial state of the lock monitoring device when the lock monitoring device is attached to a knob.

6. The lock monitoring device of claim 4, wherein the initial state comprises at least an offset degree of the lock monitoring device with respect to the predefined direction, and the controller is further configured to determine the status of the lock based on the sensed rotation degree and the offset degree.

7. The lock monitoring device of claim 1, wherein the communication module is further configured to receive a wakeup command to wake up the lock monitoring device from the external device, and the controller is further configured to wake up the lock monitoring device according to the received wakeup command.

8. The lock monitoring device of claim 1, wherein the sensor (101) is further configured to, upon sensing a motion of the lock, trigger an interrupt to wake up the lock monitoring device.

9. The lock monitoring device of claim 1, wherein the communication module is further configured to receive a sleep command to force the lock monitoring device into a sleep state from the external device, and the controller is further configured to force the lock monitoring device into the sleep state according to the received sleep command

10. The lock monitoring device of claim 1, wherein the lock monitoring device automatically enters a sleep state when a predefine time period elapses after the lock is closed.

11. The lock monitoring device of claim 1, wherein the controller is further configured to, upon detecting a change in the status of the lock,
control an alarm indicator included in the lock monitoring device to issue an alarm, and/or
control the communication module to transmit an alarm message to the external device through which the alarm message is to be reported to a user.

12. A method for monitoring a lock, the method comprising:
detecting a rotation degree of a lock with respect to a predefined direction;
determining a the status of the lock based on the detected rotation degree; and
upon detecting a change in the status of the lock, transmitting the status of the lock to an external device.

13. The method of claim 12, further comprising
keeping a history of rotation degree of the lock, and wherein determining the status of the lock comprises:
obtaining a current rotation degree of the lock,
updating the last rotation degree in the history of rotation degree with the current rotation degree if the current rotation degree is different from the last rotation degree in the history, and
determining the status of the lock based on the updated last rotation history.

14. The method of claim 12, further comprising, upon detecting a change in the status of the lock:
issuing an alarm through an alarm indicator, and/or
transmitting an alarm message to the external device through which the alarm message is to be reported to a user.

15. A system for monitoring a lock, the system comprising:
a lock monitoring device
configured to communicate with the lock monitoring device;
wherein the lock monitoring device comprises:
a sensor configured to sense a rotation degree of a lock with respect to a predefined direction;
a controller configured to determine the status of the lock based on the sensed rotation degree from the sensor; and
a communication module configured to communicate with a the first external device;
wherein the controller is further configured to, upon detecting a change in the status of the lock, control the communication module to transmit the status of the lock to the first external device, and
the first external device is further configured to present the status of the lock to a user.

16-27. (canceled)
